(19) United States
(12) Patent Application Publication
(10) Pub. No.: US 2022/0364573 A1
(43) Pub. Date: Nov. 17, 2022

(54) BEARING AND TURBOCHARGER

(71) Applicant: IHI Corporation, Tokyo (JP)

(72) Inventors: Kuniaki IIZUKA, Tokyo (JP); Ryohei KITAMURA, Tokyo (JP); Hayata SAKAIDA, Tokyo (JP); Kazuaki IWATA, Tokyo (JP); Takehiko KATO, Tokyo (JP)

(73) Assignee: IHI Corporation, Tokyo (JP)

(21) Appl. No.: 17/873,363

(22) Filed: Jul. 26, 2022

Related U.S. Application Data
(63) Continuation of application No. PCT/JP2021/005705, filed on Feb. 16, 2021.

(30) Foreign Application Priority Data
May 21, 2020 (JP) 2020-088578

(51) Int. Cl. F04D 29/063; F04D 29/056; F16C 17/02

(52) U.S. Cl. CPC F04D 29/063; F04D 29/0563; F16C 17/02; F16C 2360/24

(57) ABSTRACT

A semi-floating bearing (bearing) including: a main body, which has an annular shape, extends in a direction intersecting with a vertical direction, and has a shaft inserted through the main body; a radial bearing surface formed on an inner peripheral surface of the main body; and a plurality of oil supply grooves, which extend in an axial direction of the main body, are formed in the radial bearing surface at positions excluding a lowermost portion of the radial bearing surface in the vertical direction at intervals in a circumferential direction, and are arranged so as to be line-symmetric with each other with respect to a vertical axis in a cross section orthogonal to the axial direction of the radial bearing surface such that the interval between the oil supply grooves in the circumferential direction is the largest on a vertically lower side.

### CROSS REFERENCE TO RELATED APPLICATIONS

This application is a continuation application of International Application No. PCT/JP2021/005705, filed on Feb. 16, 2021, which claims priority to Japanese Patent Application No. 2020-088578, filed on May 21, 2020, the entire contents of which are incorporated by reference herein.

### BACKGROUND ART

### Technical Field

The present disclosure relates to a bearing and a turbocharger. This application claims the benefit of priority to Japanese Patent Application No. 2020-088578 filed on May 21, 2020, and contents thereof are incorporated herein.

### Related Art

In various devices, a bearing that axially supports a shaft in a radial direction (that is, a radial bearing) has been used. Oil supply grooves extending in an axial direction are formed in a radial bearing surface of such a bearing. Lubricating oil flows along the oil supply grooves to be supplied to the radial bearing surface. For example, in Patent Literature 1, there is disclosed a bearing in which three oil supply grooves are formed at an equal interval in a circumferential direction.

### CITATION LIST

### Patent Literature

Patent Literature 1: JP 4937588 B2

### SUMMARY

### Technical Problem

The lubricating oil between the shaft and the radial bearing surface is compressed along with rotation of the shaft. The lubricating oil is compressed so that the shaft is pressed to a radially inner side of the bearing. With this, the shaft is axially supported. When the axial direction of the shaft intersects with (for example, is orthogonal to) a vertical direction, the gravity acts on the shaft in the radial direction. Accordingly, unbalance occurs in a load acting on the bearing. As a result, a vibration of the shaft in the vertical direction (that is, a phenomenon in which the shaft is shaken in the vertical direction) is liable to occur.

The present disclosure has an object to provide a bearing and a turbocharger capable of suppressing a vibration of a shaft in a vertical direction.

### Solution to Problem

In order to solve the above-mentioned problem, according to the present disclosure, there is provided a bearing including: a main body, which has an annular shape, extends in a direction intersecting with a vertical direction, and has a shaft inserted through the main body; a radial bearing surface formed on an inner peripheral surface of the main body; and a plurality of oil supply grooves, which extend in an axial direction of the main body, are formed in the radial bearing surface at positions excluding a lowermost portion of the radial bearing surface in the vertical direction at intervals in a circumferential direction, and are arranged so as to be line-symmetric with each other with respect to a vertical axis in a cross section orthogonal to the axial direction of the radial bearing surface such that the interval between the oil supply grooves in the circumferential direction is the largest on a vertically lower side.

In order to solve the above-mentioned problem, according to the present disclosure, there is provided a bearing including: a main body, which has an annular shape, extends in a direction intersecting with a vertical direction, and has a shaft inserted through the main body; a radial bearing surface formed on an inner peripheral surface of the main body; and a plurality of oil supply grooves, which extend in an axial direction of the main body, are formed in the radial bearing surface at positions excluding a lowermost portion of the radial bearing surface in the vertical direction at intervals in a circumferential direction, and are arranged so as to be line-symmetric with each other with respect to a vertical axis in a cross section orthogonal to the axial direction of the radial bearing surface such that a larger number of oil supply grooves are formed in an upper half part than in a lower half part of the radial bearing surface in the vertical direction.

Intervals between the oil supply grooves in the circumferential direction may be equal to each other excluding the interval between the oil supply grooves in the circumferential direction on the vertically lower side.

The oil supply groove may be formed in an uppermost portion of the radial bearing surface in the vertical direction.

In order to solve the above-mentioned problem, according to the present disclosure, a turbocharger includes the above-mentioned bearing.

### Effects of Disclosure

According to the present disclosure, it is possible to suppress the vibration of the shaft in the vertical direction.

### BRIEF DESCRIPTION OF DRAWINGS

FIG. 1 is a schematic sectional view for illustrating a turbocharger.

FIG. 2 is an extracted view for illustrating a portion indicated by the one-dot chain lines of FIG. 1.

FIG. 3 is an explanatory view for illustrating a shape of a radial bearing surface in a semi-floating bearing of this embodiment.

FIG. 4 is an explanatory view for illustrating a shape of a radial bearing surface in a semi-floating bearing of a first modification example.

FIG. 5 is an explanatory view for illustrating a shape of a radial bearing surface in a semi-floating bearing of a second modification example.

FIG. 6 is an explanatory view for illustrating a shape of a radial bearing surface in a semi-floating bearing of a third modification example.

### DESCRIPTION OF EMBODIMENTS

Now, with reference to the attached drawings, one embodiment of the present disclosure is described in detail. The dimensions, materials, and other specific numerical values represented in the embodiment are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

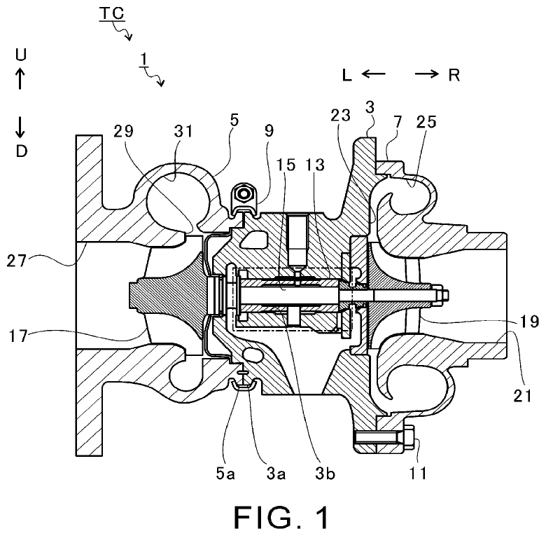

FIG. 1 is a schematic sectional view for illustrating a turbocharger TC. In FIG. 1, a direction indicated by the arrow U is a vertically upward direction, and a direction indicated by the arrow D is a vertically downward direction. In the following, description is given while a direction indicated by the arrow L illustrated in FIG. 1 corresponds to a left side of the turbocharger TC. A direction indicated by the arrow R illustrated in FIG. 1 corresponds to a right side of the turbocharger TC. As illustrated in FIG. 1, the turbocharger TC includes a turbocharger main body 1. The turbocharger main body 1 includes a bearing housing 3, a turbine housing 5, and a compressor housing 7. The turbine housing 5 is coupled to a left side of the bearing housing 3 by a fastening mechanism 9. The compressor housing 7 is coupled to a right side of the bearing housing 3 by fastening bolts 11.

A protrusion 3a is formed on an outer peripheral surface of the bearing housing 3. The protrusion 3a is formed on the turbine housing 5 side. The protrusion 3a protrudes in a radial direction of the bearing housing 3. A protrusion 5a is formed on an outer peripheral surface of the turbine housing 5. The protrusion 5a is formed on the bearing housing 3 side. The protrusion 5a protrudes in a radial direction of the turbine housing 5. The bearing housing 3 and the turbine housing 5 are band-fastened by the fastening mechanism 9. The fastening mechanism 9 is, for example, a G coupling. The fastening mechanism 9 is configured to clamp the protrusion 3a and the protrusion 5a.

The bearing housing 3 has a bearing hole 3b formed therein. The bearing hole 3b passes through the bearing housing 3 in a right-and-left direction of the turbocharger TC. A semi-floating bearing 13 is arranged in the bearing hole 3b. The semi-floating bearing 13 axially supports a shaft 15 so as to be rotatable. A turbine impeller 17 is provided at a left end portion of the shaft 15. The turbine impeller 17 is accommodated in the turbine housing 5 so as to be rotatable. A compressor impeller 19 is provided at a right end portion of the shaft 15. The compressor impeller 19 is accommodated in the compressor housing 7 so as to be rotatable.

An intake port 21 is formed in the compressor housing 7. The intake port 21 is opened on the right side of the turbocharger TC. The intake port 21 is connected to an air cleaner (not shown). A diffuser flow passage 23 is defined by the opposed surfaces of the bearing housing 3 and the compressor housing 7. The diffuser flow passage 23 increases pressure of air. The diffuser flow passage 23 has an annular shape. The diffuser flow passage 23 communicates with the intake port 21 on a radially inner side through intermediation of the compressor impeller 19.

A compressor scroll flow passage 25 is provided in the compressor housing 7. The compressor scroll flow passage 25 has an annular shape. The compressor scroll flow passage 25 is located, for example, on an outer side with respect to the diffuser flow passage 23 in a radial direction of the shaft 15. The compressor scroll flow passage 25 communicates with an intake port of an engine (not shown) and the diffuser flow passage 23. When the compressor impeller 19 rotates, the air is sucked from the intake port 21 into the compressor housing 7. The sucked air is pressurized and accelerated in the course of flowing through blades of the compressor impeller 19. The air having been pressurized and accelerated is increased in pressure in the diffuser flow passage 23 and the compressor scroll flow passage 25. The air having been increased in pressure is led to the intake port of the engine.

A discharge port 27 is formed in the turbine housing 5. The discharge port 27 is opened on the left side of the turbocharger TC. The discharge port 27 is connected to an exhaust gas purification device (not shown). A communication passage 29 and a turbine scroll flow passage 31 are formed in the turbine housing 5. The turbine scroll flow passage 31 has an annular shape. The turbine scroll flow passage 31 is located, for example, on an outer side with respect to the communication passage 29 in a radial direction of the turbine impeller 17. The turbine scroll flow passage 31 communicates with a gas inflow port (not shown). Exhaust gas discharged from an exhaust manifold of the engine (not shown) is led to the gas inflow port. The communication passage 29 allows communication between the turbine scroll flow passage 31 and the discharge port 27 through intermediation of the turbine impeller 17. The exhaust gas having been led from the gas inflow port to the turbine scroll flow passage 31 is led to the discharge port 27 through intermediation of the communication passage 29 and the turbine impeller 17. The exhaust gas led to the discharge port 27 rotates turbine impeller 17 in the course of flowing.

A rotational force of the turbine impeller 17 is transmitted to the compressor impeller 19 through the shaft 15. When the compressor impeller 19 rotates, the pressure of the air is increased as described above. In such a manner, the air is led to the intake port of the engine.

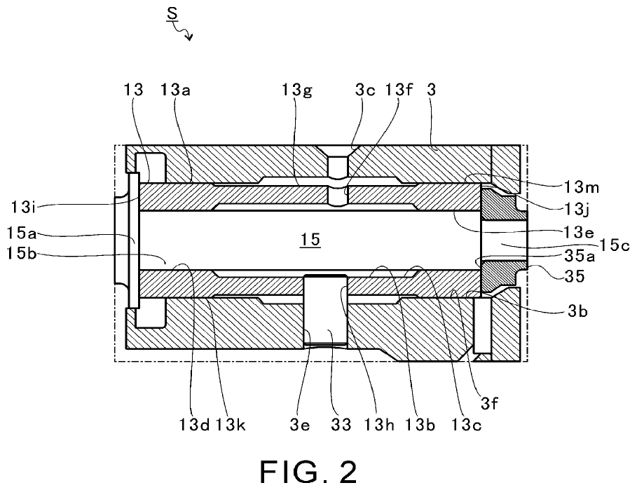

FIG. 2 is an extracted view for illustrating a portion indicated by the one-dot chain lines of FIG. 1. As illustrated in FIG. 2, the bearing housing 3 has a bearing structure S therein. The bearing structure S includes the bearing hole 3b, the semi-floating bearing 13, and the shaft 15.

An oil passage 3c is formed in the bearing housing 3. Lubricating oil is supplied to the oil passage 3c. The oil passage 3c is opened (that is, communicates with) the bearing hole 3b. The oil passage 3c leads the lubricating oil to the bearing hole 3b. The lubricating oil flows into the bearing hole 3b from the oil passage 3c.

The semi-floating bearing 13 is arranged in the bearing hole 3b. The semi-floating bearing 13 includes a main body 13a having an annular shape. The main body 13a has an insertion hole 13b. The insertion hole 13b passes through the main body 13a in an axial direction of the shaft 15. The axial direction of the shaft 15 intersects with (specifically, is orthogonal to) a vertical direction. The shaft 15 is inserted through the insertion hole 13b. The main body 13a extends in a direction intersecting with (specifically, a direction orthogonal to) the vertical direction. In the following, an axial direction, a radial direction, and a circumferential direction of the semi-floating bearing 13 (that is, an axial direction, a radial direction, and a circumferential direction of the main body 13a and the shaft 15) are also simply referred to as “axial direction”, “radial direction”, and “circumferential direction”, respectively.

Two radial bearing surfaces 13d and 13e are formed on an inner peripheral surface 13c of the main body 13a (insertion hole 13b). The two radial bearing surfaces 13d and 13e are arranged so as to be apart from each other in the axial direction. An oil hole 13f is formed in the main body 13a. The oil hole 13f passes through the main body 13a from the inner peripheral surface 13c to an outer peripheral surface 13g. The oil hole 13f is arranged between the two radial bearing surfaces 13d and 13e. The oil hole 13f is opposed to an opening of the oil passage 3c in the radial direction of the semi-floating bearing 13.

The lubricating oil flows into the inner peripheral surface 13c side from the outer peripheral surface 13g side of the main body 13a through the oil hole 13f. The lubricating oil having flowed into the inner peripheral surface 13c side of the main body 13a moves along the circumferential direction between the inner peripheral surface 13c and the shaft 15. Further, the lubricating oil having flowed into the inner peripheral surface 13c side of the main body 13a moves along the axial direction (right-and-left direction of FIG. 2) between the inner peripheral surface 13c and the shaft 15. The lubricating oil is supplied to a clearance defined between the shaft 15 and the two radial bearing surfaces 13d and 13e. The shaft 15 is axially supported by oil film pressure of the lubricating oil. The two radial bearing surfaces 13d and 13e receive radial loads of the shaft 15.

The main body 13a has a through hole 13h. The through hole 13h passes through the main body 13a from the inner peripheral surface 13c to the outer peripheral surface 13g. The through hole 13h is arranged between the two radial bearing surfaces 13d and 13e. The through hole 13h is arranged in the main body 13a on a side opposite to a side on which the oil hole 13f is formed. However, the present disclosure is not limited thereto, and the position of the through hole 13h is only required to be different from the position of the oil hole 13f in the circumferential direction.

The bearing housing 3 has a pin hole 3e. The pin hole 3e is formed in the bearing hole 3b at a position opposed to the through hole 13h. The pin hole 3e passes through a wall portion forming the bearing hole 3b. The pin hole 3e allows communication between an inner space and an outer space of the bearing hole 3b. A positioning pin 33 is inserted through the pin hole 3e. Specifically, the positioning pin 33 is press-fitted into the pin hole 3e. A distal end of the positioning pin 33 is inserted through the through hole 13h of the main body 13a. The positioning pin 33 restricts movement of the main body 13a in a rotation direction and the axial direction.

The shaft 15 includes a large-diameter portion 15a, a medium-diameter portion 15b, and a small-diameter portion 15c. The large-diameter portion 15a is located on the turbine impeller 17 (see FIG. 1) side with respect to the main body 13a. The large-diameter portion 15a has a cylindrical shape. An outer diameter of the large-diameter portion 15a is larger than an inner diameter of the inner peripheral surface 13c (specifically, the radial bearing surface 13d) of the main body 13a. The outer diameter of the large-diameter portion 15a is larger than an outer diameter of the outer peripheral surface 13g of the main body 13a. However, the outer diameter of the large-diameter portion 15a may be equal to or smaller than the outer diameter of the outer peripheral surface 13g of the main body 13a. The large-diameter portion 15a is opposed to the main body 13a in the axial direction. The large-diameter portion 15a has a constant outer diameter. However, the outer diameter of the large-diameter portion 15a is not required to be constant.

The medium-diameter portion 15b is located on the compressor impeller 19 (see FIG. 1) side with respect to the large-diameter portion 15a. The medium-diameter portion 15b has a cylindrical shape. The medium-diameter portion 15b is inserted through the insertion hole 13b of the main body 13a. Thus, the medium-diameter portion 15b is opposed to the inner peripheral surface 13c of the insertion hole 13b in the radial direction. The medium-diameter portion 15b has an outer diameter smaller than that of the large-diameter portion 15a. The outer diameter of the medium-diameter portion 15b is smaller than an inner diameter of the radial bearing surfaces 13d and 13e of the main body 13a. The medium-diameter portion 15b has a constant outer diameter. However, the outer diameter of the medium-diameter portion 15b is not required to be constant.

The small-diameter portion 15c is located on the compressor impeller 19 (see FIG. 1) side with respect to the medium-diameter portion 15b (and the main body 13a). The small-diameter portion 15c has a cylindrical shape. The small-diameter portion 15c has an outer diameter smaller than that of the medium-diameter portion 15b. The small-diameter portion 15c has a constant outer diameter. However, the outer diameter of the small-diameter portion 15c is not required to be constant.

An oil thrower member 35 having an annular shape is inserted through the small-diameter portion 15c. The oil thrower member 35 scatters the lubricating oil flowing along the shaft 15 to the compressor impeller 19 side to the radially outer side. That is, the oil thrower member 35 suppresses leakage of the lubricating oil to the compressor impeller 19 side.

The oil thrower member 35 has an outer diameter larger than that of the medium-diameter portion 15b. The outer diameter of the oil thrower member 35 is larger than the inner diameter of the inner peripheral surface 13c (specifically, the radial bearing surface 13e) of the main body 13a. The outer diameter of the oil thrower member 35 is smaller than an outer diameter of the outer peripheral surface 13g of the main body 13a. However, the outer diameter of the oil thrower member 35 may be equal to or larger than the outer diameter of the outer peripheral surface 13g of the main body 13a. The oil thrower member 35 is opposed to the main body 13a in the axial direction.

The main body 13a is sandwiched by the oil thrower member 35 and the large-diameter portion 15a in the axial direction. The lubricating oil is supplied to a clearance defined between the main body 13a and the oil thrower member 35. The lubricating oil is supplied to a clearance defined between the main body 13a and the large-diameter portion 15a.

When the shaft 15 moves in the axial direction (left side of FIG. 2), a load acting in the axial direction is borne by oil film pressure of the lubricating oil between the main body 13a and the oil thrower member 35. When the shaft 15 moves in the axial direction (right side of FIG. 2), the load acting in the axial direction is borne by oil film pressure of the lubricating oil between the main body 13a and the large-diameter portion 15a. That is, both end surfaces of the main body 13a in the axial direction are thrust bearing surfaces 13i and 13j that receive thrust loads.

Damper portions 13k and 13m are formed on the outer peripheral surface 13g of the main body 13a. The damper portions 13k and 13m are apart from each other in the axial direction. The damper portions 13k and 13m are formed at both end portions of the outer peripheral surface 13g in the axial direction. The outer diameter of the damper portions 13k and 13m is larger than an outer diameter of other portions of the outer peripheral surface 13g. The lubricating oil is supplied to clearances s defined between the damper portions 13k and 13m and an inner peripheral surface 3f of the bearing hole 3b. A vibration of the shaft 15 is suppressed by the oil film pressure of the lubricating oil.

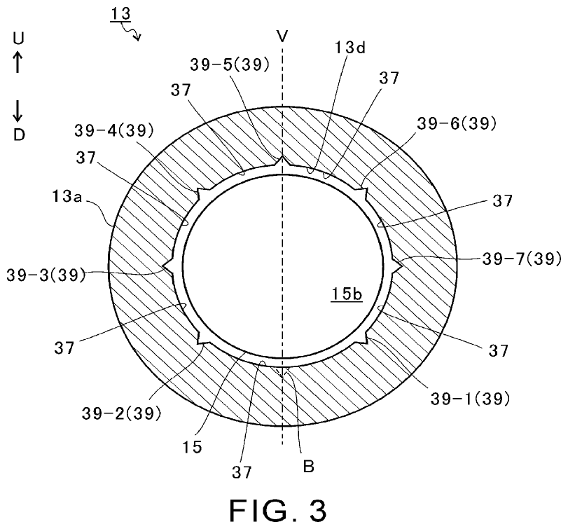

FIG. 3 is an explanatory view for illustrating a shape of the radial bearing surface 13d in the semi-floating bearing 13 of this embodiment. FIG. 3 is a view for illustrating a transverse cross section (that is, a cross section orthogonal to the axial direction) of a portion in which the radial bearing surface 13d is formed in the main body 13a. Here, a sectional shape of the radial bearing surface 13d is described. The radial bearing surface 13e has a shape substantially equal to that of the radial bearing surface 13d. Thus, description of the shape of the radial bearing surface 13e is omitted.

As illustrated in FIG. 3, a plurality of arc surfaces 37 and a plurality of oil supply grooves 39 are formed in the radial bearing surface 13d. In the semi-floating bearing 13 of this embodiment, the radial bearing surface 13d has seven arc surfaces 37 and seven oil supply grooves 39 (specifically, oil supply grooves 39-1, 39-2, 39-3, 39-4, 39-5, 39-6, and 39-7). However, the present disclosure is not limited thereto, and the number of arc surfaces 37 and the number of oil supply grooves 39 may be other than seven.

The plurality of arc surfaces 37 are apart from the shaft 15 in the radial direction. The plurality of arc surfaces 37 are arrayed in the circumferential direction. The positions of the curvature centers of the plurality of arc surfaces 37 match each other. That is, the plurality of arc surfaces 37 are located on the same cylindrical surface. The oil supply groove 39 is formed between two arc surfaces 37 adjacent to each other in the circumferential direction. The oil supply grooves 39 are formed in the radial bearing surface 13d at intervals in the circumferential direction. The oil supply grooves 39 are formed in the radial bearing surface 13d so as to extend in the axial direction. A transverse sectional shape (that is, a shape in a cross section orthogonal to the axial direction) of the oil supply groove 39 is a shape in which a width in the circumferential direction becomes smaller toward the radially outer side (specifically, a triangular shape). However, the transverse sectional shape of the oil supply groove 39 may be a rectangular shape, a semicircular shape, or a polygonal shape.

The oil supply groove 39 extends from an end portion of the radial bearing surface 13d at which the two radial bearing surfaces 13d and 13e (see FIG. 2) are close to each other to an end portion of the radial bearing surface 13d at which the two radial bearing surfaces 13d and 13e are apart from each other. The oil supply groove 39 is opened to the thrust bearing surface 13i (that is, an end surface of the main body 13a in the axial direction). The oil supply groove 39 allows the lubricating oil to flow therethrough. The oil supply groove 39 supplies the lubricating oil to the radial bearing surface 13d. Further, the oil supply groove 39 supplies the lubricating oil to the thrust bearing surface 13i.

The lubricating oil between the shaft 15 and the radial bearing surface 13d moves in the rotation direction of the shaft 15 along with rotation of the shaft 15. At this time, the lubricating oil is compressed between the arc surfaces 37 of the radial bearing surface 13d and the shaft 15. The compressed lubricating oil presses the shaft 15 to the radially inner side (that is, a radial direction) (wedge effect). With this, the load acting in the radial direction is borne by the radial bearing surface 13d.

In the semi-floating bearing 13 of this embodiment, arrangement of the oil supply grooves 39 in the radial bearing surface 13d is devised, thereby suppressing the vibration of the shaft 15 in the vertical direction. In the following, arrangement of the oil supply grooves 39 in the radial bearing surface 13d is described in detail.

Herein, the fact that the oil supply groove 39 is formed in a lowermost portion of the radial bearing surface 13d in the vertical direction means that the oil supply groove 39 is formed so as to straddle a portion of the radial bearing surface 13d, which is located vertically below a center axis of the semi-floating bearing 13. The fact that the oil supply groove 39 is formed in an uppermost portion of the radial bearing surface 13d in the vertical direction means that the oil supply groove 39 is formed so as to straddle a portion of the radial bearing surface 13d, which is located vertically above the center axis of the semi-floating bearing 13.

In the semi-floating bearing 13, the oil supply grooves 39 are formed in the radial bearing surface 13d at positions excluding the lowermost portion thereof in the vertical direction (that is, the oil supply grooves 39 are not formed in the lowermost portion of the radial bearing surface 13d in the vertical direction). The oil supply grooves 39 are arranged so as to be line-symmetric with each other with respect to a vertical axis V in a transverse cross section of the radial bearing surface 13d. The interval between the oil supply grooves 39 in the circumferential direction is the largest on the vertically lower side. A larger number of oil supply grooves 39 are formed in an upper half part than in a lower half part of the radial bearing surface 13d in the vertical direction.

Specifically, in the semi-floating bearing 13, in the arrangement of the oil supply grooves 39, the oil supply groove 39 in the lowermost portion of the radial bearing surface 13d in the vertical direction is eliminated as indicated by the broken line B from arrangement in which eight oil supply grooves 39 are arranged at an equal interval in the circumferential direction such that one oil supply groove 39 (oil supply groove 39-5 of FIG. 3) is formed in the uppermost portion of the radial bearing surface 13d in the vertical direction.

The oil supply grooves 39-1, 39-2, 39-3, 39-4, 39-5, 39-6, and 39-7 are arrayed in the stated order in the circumferential direction. The oil supply grooves 39-1 and 39-2 are formed in the lower half part of the radial bearing surface 13d in the vertical direction. The oil supply grooves 39-3 and 39-7 are formed at the center position of the radial bearing surface 13d in the vertical direction. The oil supply grooves 39-4, 39-5, and 39-6 are formed in the upper half part of the radial bearing surface 13d in the vertical direction. The oil supply groove 39-5 is formed in the uppermost portion of the radial bearing surface 13d in the vertical direction. The oil supply groove 39-2 and the oil supply groove 39-1 are arranged so as to be line-symmetric with each other with respect to the vertical axis V. The oil supply groove 39-3 and the oil supply groove 39-7 are arranged so as to be line-symmetric with each other with respect to the vertical axis V. The oil supply groove 39-4 and the oil supply groove 39-6 are arranged so as to be line-symmetric with each other with respect to the vertical axis V.

The interval between the oil supply groove 39-1 and the oil supply groove 39-2 (that is, the interval between the oil supply grooves 39 in the circumferential direction on the vertically lower side) is larger than the intervals between other oil supply grooves 39. The intervals between the oil supply grooves 39 in the circumferential direction other than the interval between the oil supply groove 39-1 and the oil supply groove 39-2 are equal to each other. With this, the lubricating oil is easily spread over the entire radial bearing surface 13d. However, the intervals between the oil supply grooves 39 in the circumferential direction other than the interval between the oil supply groove 39-1 and the oil supply groove 39-2 may be different from each other.

As described above, the oil supply grooves 39 are arranged so as to be line-symmetric with each other with respect to the vertical axis V in a transverse cross section of the radial bearing surface 13d. With this, the bearing force for the shaft 15 by the radial bearing surface 13d is uniformized in the left direction and the right direction in the direction orthogonal to the vertical direction (right-and-left direction of FIG. 3). Further, even when the rotation direction of the shaft 15 is reversed, the bearing force for the shaft 15 by the radial bearing surface 13d is generated in the same distribution as that before the rotation direction of the shaft 15 is reversed.

As described above, the oil supply grooves 39 are formed in the radial bearing surface 13d at positions excluding the lowermost portion thereof in the vertical direction (that is, the oil supply grooves 39 are not formed in the lowermost portion of the radial bearing surface 13d in the vertical direction). With this, the arc surface 37 (specifically, the arc surface 37 between the oil supply groove 39-1 and the oil supply groove 39-2) is formed in the vertically lower portion of the radial bearing surface 13d. Accordingly, as compared to a case in which the oil supply groove 39 is formed in the vertically lower portion of the radial bearing surface 13d, the bearing force for supporting the shaft 15 vertically upward increases in a portion of the radial bearing surface 13d on the vertically lower side. Thus, the vibration of the shaft 15 in the vertical direction caused by the gravity acting on the shaft 15 is suppressed.

As described above, the interval between the oil supply grooves 39 in the circumferential direction is the largest on the vertically lower side. With this, the area of the arc surface 37 formed in the vertically lower portion of the radial bearing surface 13d (specifically, the arc surface 37 between the oil supply groove 39-1 and the oil supply groove 39-2) is larger than the areas of other arc surfaces 37. Accordingly, the bearing force for supporting the shaft 15 vertically upward increases effectively in the portion of the radial bearing surface 13d on the vertically lower side. Thus, the vibration of the shaft 15 in the vertical direction caused by the gravity acting on the shaft 15 is effectively suppressed.

As described above, a larger number of oil supply grooves 39 are formed in the upper half part than in the lower half part of the radial bearing surface 13d in the vertical direction. With this, the area of the arc surface 37 formed in the vertically lower portion of the radial bearing surface 13d (specifically, the arc surface 37 between the oil supply groove 39-1 and the oil supply groove 39-2) can be made larger than the areas of the arc surfaces 37 formed in the upper half part of the radial bearing surface 13d in the vertical direction. Accordingly, the bearing force for supporting the shaft 15 vertically upward increases effectively in the portion of the radial bearing surface 13d on the vertically lower side. Thus, the vibration of the shaft 15 in the vertical direction caused by the gravity acting on the shaft 15 is effectively suppressed.

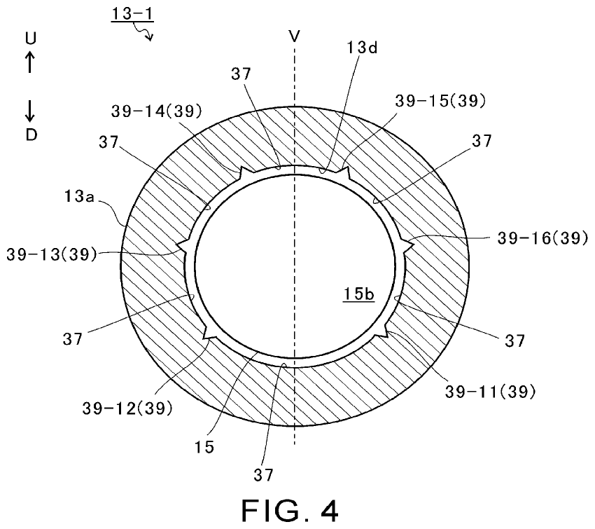

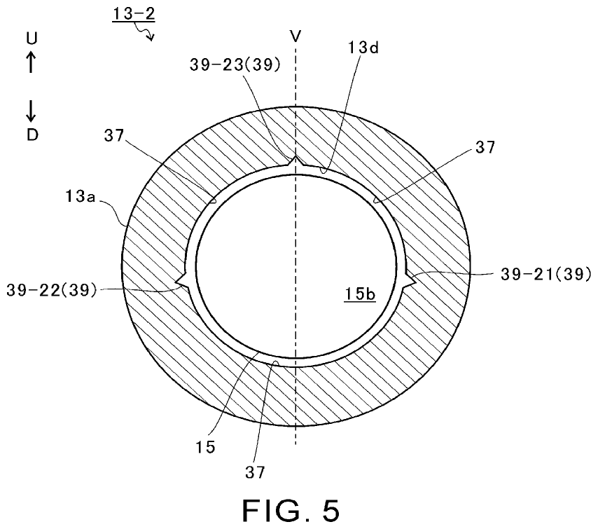

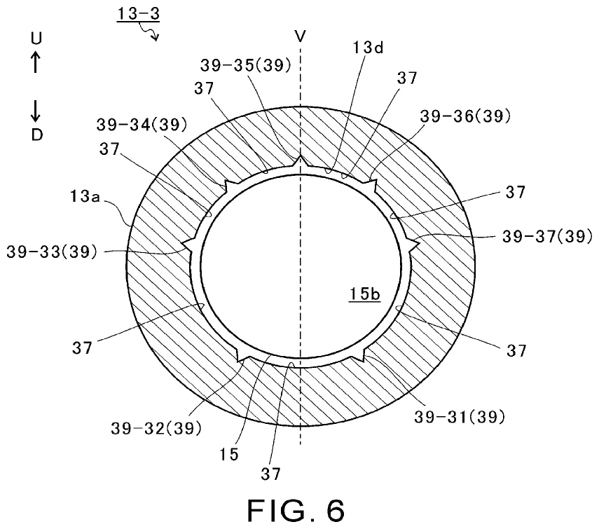

In the above, an example of the arrangement of the oil supply grooves 39 in the radial bearing surface 13d is described with reference to FIG. 3. However, the arrangement of the oil supply grooves 39 in the radial bearing surface 13d is not limited to the example of FIG. 3. In the following, with reference to FIG. 4, FIG. 5, and FIG. 6, a first modification example, a second modification example, and a third modification example, which are different from the example of FIG. 3 in the arrangement of the oil supply grooves 39 in the radial bearing surface 13d, are described. FIG. 4, FIG. 5, and FIG. 6 are views each for illustrating a transverse cross section of a portion of the main body 13a in which the radial bearing surface 13d is formed, similarly to FIG. 3.

FIG. 4 is an explanatory view for illustrating a shape of a radial bearing surface 13d in a semi-floating bearing 13-1 of the first modification example. As illustrated in FIG. 4, in the radial bearing surface 13d of the semi-floating bearing 13-1, six arc surfaces 37 and six oil supply grooves 39 (specifically, oil supply grooves 39-11, 39-12, 39-13, 39-14, 39-15, and 39-16) are formed. The semi-floating bearing 13-1 is different from the semi-floating bearing 13 illustrated in FIG. 3 in that the oil supply groove 39 is not formed in the uppermost portion of the radial bearing surface 13d in the vertical direction.

Specifically, the oil supply grooves 39-11, 39-12, 39-13, 39-14, 39-15, and 39-16 are arrayed in the stated order in the circumferential direction. The oil supply grooves 39-11 and 39-12 are formed in the lower half part of the radial bearing surface 13d in the vertical direction. The oil supply grooves 39-13, 39-14, 39-15, and 39-16 are formed in the upper half part of the radial bearing surface 13d in the vertical direction. The oil supply groove 39-12 and the oil supply groove 39-11 are arranged so as to be line-symmetric with each other with respect to the vertical axis V. The oil supply groove 39-13 and the oil supply groove 39-16 are arranged so as to be line-symmetric with each other with respect to the vertical axis V. The oil supply groove 39-14 and the oil supply groove 39-15 are arranged so as to be line-symmetric with each other with respect to the vertical axis V.

The interval between the oil supply groove 39-11 and the oil supply groove 39-12 (that is, the interval between the oil supply grooves 39 in the circumferential direction on the vertically lower side) is larger than the intervals between other oil supply grooves 39. The intervals between the oil supply grooves 39 in the circumferential direction other than the interval between the oil supply groove 39-11 and the oil supply groove 39-12 are equal to each other. However, the intervals between the oil supply grooves 39 in the circumferential direction other than the interval between the oil supply groove 39-11 and the oil supply groove 39-12 may be different from each other.

As in the semi-floating bearing 13-1 illustrated in FIG. 4, the oil supply groove 39 is not required to be formed in the uppermost portion of the radial bearing surface 13d in the vertical direction. However, when the oil supply groove 39 (specifically, the oil supply groove 39-5 of FIG. 3) is formed in the uppermost portion of the radial bearing surface 13d in the vertical direction as in the semi-floating bearing 13 illustrated in FIG. 3, the bearing force for supporting the shaft 15 vertically downward decreases in a portion of the radial bearing surface 13d on the vertically upper side as compared to a case in which the oil supply groove 39 is not formed in the uppermost portion of the radial bearing surface 13d in the vertical direction. Thus, the vibration of the shaft 15 in the vertical direction caused by the gravity acting on the shaft 15 is suppressed.

FIG. 5 is an explanatory view for illustrating a shape of a radial bearing surface 13d in a semi-floating bearing 13-2 of the second modification example. As illustrated in FIG. 5, in the radial bearing surface 13d of the semi-floating bearing 13-2, three arc surfaces 37 and three oil supply grooves 39 (specifically, oil supply grooves 39-21, 39-22, and 39-23) are formed. The semi-floating bearing 13-2 is different from the semi-floating bearing 13 illustrated in FIG. 3 in that a larger number of oil supply grooves 39 are formed in the lower half part than in the upper half part of the radial bearing surface 13d in the vertical direction.

Specifically, the oil supply grooves 39-21, 39-22, and 39-23 are arrayed in the stated order in the circumferential direction. The oil supply grooves 39-21 and 39-22 are formed in the lower half part of the radial bearing surface 13d in the vertical direction. The oil supply groove 39-23 is formed in the upper half part of the radial bearing surface 13d in the vertical direction. The oil supply groove 39-23 is formed in the uppermost portion of the radial bearing surface 13d in the vertical direction. The oil supply groove 39-22 and the oil supply groove 39-21 are arranged so as to be line-symmetric with each other with respect to the vertical axis V.

The interval between the oil supply groove 39-21 and the oil supply groove 39-22 (that is, the interval between the oil supply grooves 39 in the circumferential direction on the vertically lower side) is larger than the intervals between other oil supply grooves 39. The intervals between the oil supply grooves 39 in the circumferential direction other than the interval between the oil supply groove 39-21 and the oil supply groove 39-22 are equal to each other. However, the intervals between the oil supply grooves 39 in the circumferential direction other than the interval between the oil supply groove 39-21 and the oil supply groove 39-22 may be different from each other.

As in the semi-floating bearing 13-2 illustrated in FIG. 5, a larger number of oil supply grooves 39 may be formed in the lower half part than in the upper half part of the radial bearing surface 13d in the vertical direction. In the semi-floating bearing 13-2, the interval between the oil supply grooves 39 in the circumferential direction is the largest on the vertically lower side. With this, the area of the arc surface 37 formed in the vertically lower portion of the radial bearing surface 13d (specifically, the arc surface 37 between the oil supply groove 39-21 and the oil supply groove 39-22) is larger than the areas of other arc surfaces 37. Accordingly, the bearing force for supporting the shaft 15 vertically upward increases effectively in the portion of the radial bearing surface 13d on the vertically lower side. Thus, the vibration of the shaft 15 in the vertical direction caused by the gravity acting on the shaft 15 is effectively suppressed.

FIG. 6 is an explanatory view for illustrating a shape of a radial bearing surface 13d in a semi-floating bearing 13-3 of the third modification example. As illustrated in FIG. 6, in the radial bearing surface 13d of the semi-floating bearing 13-3, seven arc surfaces 37 and seven oil supply grooves 39 (specifically, oil supply grooves 39-31, 39-32, 39-33, 39-34, 39-35, 39-36, and 39-37) are formed. The semi-floating bearing 13-3 is different from the semi-floating bearing 13 illustrated in FIG. 3 in that the interval between the oil supply grooves 39 in the circumferential direction is not the largest on the vertically lower side.

Specifically, the oil supply grooves 39-31, 39-32, 39-33, 39-34, 39-35, 39-36, and 39-37 are arrayed in the stated order in the circumferential direction. The oil supply grooves 39-31 and 39-32 are formed in the lower half part of the radial bearing surface 13d in the vertical direction. The oil supply grooves 39-33, 39-34, 39-35, 39-36, and 39-37 are formed in the upper half part of the radial bearing surface 13d in the vertical direction. The oil supply groove 39-35 is formed in the uppermost portion of the radial bearing surface 13d in the vertical direction. The oil supply groove 39-32 and the oil supply groove 39-31 are arranged so as to be line-symmetric with each other with respect to the vertical axis V. The oil supply groove 39-33 and the oil supply groove 39-37 are arranged so as to be line-symmetric with each other with respect to the vertical axis V. The oil supply groove 39-34 and the oil supply groove 39-36 are arranged so as to be line-symmetric with each other with respect to the vertical axis V.

The interval between the oil supply groove 39-32 and the oil supply groove 39-33 and the interval between the oil supply groove 39-31 and the oil supply groove 39-37 are equal to each other. Those intervals are the largest among the intervals between the oil supply grooves 39 in the circumferential direction. The interval between the oil supply groove 39-31 and the oil supply groove 39-32 (that is, the interval between the oil supply grooves 39 in the circumferential direction on the vertically lower side) is the second largest among the intervals between the oil supply grooves 39 in the circumferential direction. The interval between the oil supply groove 39-33 and the oil supply groove 39-34, the interval between the oil supply groove 39-34 and the oil supply groove 39-35, the interval between the oil supply groove 39-35 and the oil supply groove 39-36, and the interval between the oil supply groove 39-36 and the oil supply groove 39-37 are equal to each other. Those intervals are the smallest among the intervals between the oil supply grooves 39 in the circumferential direction.

The interval between the oil supply grooves 39 in the circumferential direction is not required to be the largest on the vertically lower side as in the semi-floating bearing 13-3 illustrated in FIG. 6. In the semi-floating bearing 13-3, a larger number of oil supply grooves 39 are formed in the upper half part than in the lower half part of the radial bearing surface 13d in the vertical direction. With this, the area of the arc surface 37 formed in the vertically lower portion of the radial bearing surface 13d (specifically, the arc surface 37 between the oil supply groove 39-31 and the oil supply groove 39-32) can be made larger than the area of the arc surface 37 formed in the upper half part of the radial bearing surface 13d in the vertical direction. Accordingly, the bearing force for supporting the shaft 15 vertically upward increases effectively in the portion of the radial bearing surface 13d on the vertically lower side. Thus, the vibration of the shaft 15 in the vertical direction caused by the gravity acting on the shaft 15 is effectively suppressed.

An embodiment of the present disclosure has been described above with reference to the attached drawings, but, needless to say, the present disclosure is not limited to the above-mentioned embodiment. It is apparent that those skilled in the art may arrive at various alternations and modifications within the scope of claims, and those examples are construed as naturally falling within the technical scope of the present disclosure.

In the above, an example in which the bearing is the semi-floating bearing 13 has been described. However, the present disclosure is not limited thereto, and the bearing is not required to be formed separately from a housing (for example, the bearing housing 3) but may be formed integrally with the housing.

In the above, an example in which the positions of the curvature centers of the plurality of arc surfaces 37 match each other has been described. However, the present disclosure is not limited thereto, and the positions of the curvature centers of the plurality of arc surfaces 37 may be different from each other. In this case, curvature radii of the plurality of arc surfaces 37 may be equal to each other or may be different from each other.

What is claimed is:

1. A bearing, comprising:
a main body, which has an annular shape, extends in a direction intersecting with a vertical direction, and has a shaft inserted through the main body;
a radial bearing surface formed on an inner peripheral surface of the main body; and
a plurality of oil supply grooves, which extend in an axial direction of the main body, are formed in the radial bearing surface at positions excluding a lowermost portion of the radial bearing surface in the vertical direction at intervals in a circumferential direction, and are arranged so as to be line-symmetric with each other with respect to a vertical axis in a cross section orthogonal to the axial direction of the radial bearing surface such that the interval between the oil supply grooves in the circumferential direction is the largest on a vertically lower side.

2. A bearing, comprising:
a main body, which has an annular shape, extends in a direction intersecting with a vertical direction, and has a shaft inserted through the main body;
a radial bearing surface formed on an inner peripheral surface of the main body; and
a plurality of oil supply grooves, which extend in an axial direction of the main body, are formed in the radial bearing surface at positions excluding a lowermost portion of the radial bearing surface in the vertical direction at intervals in a circumferential direction, and are arranged so as to be line-symmetric with each other with respect to a vertical axis in a cross section orthogonal to the axial direction of the radial bearing surface such that a larger number of oil supply grooves are formed in an upper half part than in a lower half part of the radial bearing surface in the vertical direction.

3. The bearing according to claim 1, wherein intervals between the oil supply grooves in the circumferential direction are equal to each other excluding the interval between the oil supply grooves in the circumferential direction on the vertically lower side.

4. The bearing according to claim 2, wherein intervals between the oil supply grooves in the circumferential direction are equal to each other excluding the interval between the oil supply grooves in the circumferential direction on the vertically lower side.

5. The bearing according to claim 1, wherein the oil supply groove is formed in an uppermost portion of the radial bearing surface in the vertical direction.

6. The bearing according to claim 2, wherein the oil supply groove is formed in an uppermost portion of the radial bearing surface in the vertical direction.

7. The bearing according to claim 3, wherein the oil supply groove is formed in an uppermost portion of the radial bearing surface in the vertical direction.

8. The bearing according to claim 4, wherein the oil supply groove is formed in an uppermost portion of the radial bearing surface in the vertical direction.

9. A turbocharger, comprising the bearing of claim 1.

10. A turbocharger, comprising the bearing of claim 2.

11. A turbocharger, comprising the bearing of claim 3.

12. A turbocharger, comprising the bearing of claim 4.

13. A turbocharger, comprising the bearing of claim 5.

14. A turbocharger, comprising the bearing of claim 6.

15. A turbocharger, comprising the bearing of claim 7.

16. A turbocharger, comprising the bearing of claim 8.
